(19) United States
(12) Patent Application Publication
(10) Pub. No.: US 2023/0083285 A1
(43) Pub. Date: Mar. 16, 2023

(54) FINAL EXPONENTIATION COMPUTATION DEVICE, PAIRING COMPUTATION DEVICE, CRYPTOGRAPHIC PROCESSING DEVICE, FINAL EXPONENTIATION COMPUTATION METHOD, AND COMPUTER READABLE MEDIUM

(71) Applicant: Mitsubishi Electric Corporation, Tokyo (JP)

(72) Inventors: Daiki HAYASHIDA, Tokyo (JP); Kenichiro HAYASAKA, Tokyo (JP)

(73) Assignee: Mitsubishi Electric Corporation, Tokyo (JP)

(21) Appl. No.: 17/989,780

(22) Filed: Nov. 18, 2022

Related U.S. Application Data
(63) Continuation of application No. PCT/JP2020/026843, filed on Jul. 9, 2020.

(51) Int. Cl. G06F 9/30; G06F 17/15

(52) U.S. Cl. CPC G06F 9/3001; G06F 17/156

(57) ABSTRACT

A decomposition unit (211) decomposes an exponent portion of a final exponentiation computation portion of pairing computation in an elliptic curve into an easy part and a hard part with using a polynomial Φₖ(p(x)), the elliptic curve being expressed by: a polynomial r(x)=Φₖ(T(x))/h₂(x), a polynomial p(x)=h₁(x)r(x)+T(x), and a polynomial t(x)=T(x)+1 which are expressed with using a cyclotomic polynomial Φₖ(x) having a degree d, a polynomial T(x), a polynomial h₁(x), and a polynomial h₂(x); and an embedding degree k. An exponentiation computation unit (22) computes the hard part with using a power of a polynomial p(x)ⁱ for each integer i of i=0, . . . , d−1, a power of λ_{d-i}(x) where λ_{d-i}(x)=c_{d}, a power of λᵢ where λᵢ=T(x)λᵢ₊₁(x)+cᵢ₊₁ for each integer i of i=0, . . . , d−2, a power of h₁(x), a power of h₂(x), multiplication, and inverse element computation.

### CROSS-REFERENCE TO RELATED APPLICATION

This application is a continuation application of International Application PCT/JP2020/026843, filed on Jul. 9, 2020, all of which is hereby expressly incorporated by reference into the present application.

### TECHNICAL FIELD

The present disclosure relates to a computation technique of final exponentiation in pairing computation.

### BACKGROUND ART

Pairing computation is a computation that uses elliptic curves processed in a cryptographic method such as functional encryption and searchable encryption. An elliptic curve appropriate for efficient computation of pairing computation is called a pairing-friendly curve. Conventionally, a Barret-Naehrig (BN) curve has been known as a pairing-friendly curve corresponding to 128-bit security. However, since around 2016, the security has been reviewed, and there is an increasing interest for pairing computation that uses various pairing-friendly curves such as a Barreto-Lynn-Scott (BLS) curve and a Kachisa-Schaefer-Scott (KSS) curve.

The pairing computation can be roughly classified into computation of a Miller function and computation of final exponentiation. Both the computation of the Miller function and the computation of the final exponentiation require a complicated computation process, which largely influences a computation amount of an entire cryptographic method such as functional encryption and searchable encryption.

Non-Patent Literatures 1 and 2 describe the BLS curve which is regarded to have a high efficiency in the entire pairing computation among many pairing-friendly curves. Non-Patent Literatures 1 and 2 describe pairing computation in BLS curves with an embedding degree k of k=24, 27, 42, and 48. Patent Literature 1 and Non-Patent Literature 2 describe the KSS curves. Any of these literatures shows a result that a computation amount of final exponentiation is larger than a computation amount of the Miller function.

A pairing-friendly curve is an elliptic curve determined by a polynomial r(x), a polynomial p(x), a polynomial t(x), an embedding degree k, an integer D, and an integer u. The polynomial r(x), the polynomial p(x), and the polynomial t(x) have different forms depending on the embedding degree k.

A pairing-friendly curve E with an embedding degree k is an elliptic curve defined over a finite field Fₚ consisting of p=p(x) elements. Note that r=r(x) is a maximum prime that divides an order of a subgroup E(Fₚ) of the elliptic curve E. Note that t=t(x) is a trace of the elliptic curve E.

Pairing computation on the elliptic curve E is performed by taking as input two certain points P and Q on the elliptic curve E, computing a rational function f called the Miller function, and after that raising the computation result to a power of (p(x)^{k}−1)/r(x). Namely, the pairing computation on the elliptic curve E is performed by Formula 11.

$${f}^{\frac{{p ( x )}^{k} - 1}{r ( x )}} \qquad [ Formula 11 ]$$

In description of Non-Patent Literature 3, in order to efficiently compute the final exponentiation, an exponent portion (p(x)^{k}−1)/r(x) is decomposed into an easy part and a hard part with using a polynomial Φₖ(p(x)).

Exponentiation computation of the easy part can be efficiently performed using a fast power of p(x)ⁱ. In exponentiation computation of the hard part, as indicated by Formula 12, an exponent portion of the hard part is transformed into a linear sum of p(x)ⁱ, and exponentiation by each coefficient λᵢ(x) is computed.

$$\frac{{Φ}_{k} ( p ( x ) )}{r ( x )} = {\sum }_{i} {λ}_{i} ( x ) {p ( x )}^{i} \qquad [ Formula 12 ]$$

### CITATION LIST

### Patent Literature

Patent Literature 1: JP 2018-205511 A

### Non-Patent Literature

Non-Patent Literature 1: X. Zhang, D. Lin, “Analysis of Optimum Pairing Products at High Security Levels”, INDOCRYPT 2012, p. 412-430
Non-Patent Literature 2: Y. Kiyomura, A. Inoue, Y. Kawahara, M. Yasuda, T. Takagi, T. Kobayashi, “Secure and Efficient Pairing at 256-Bit Security Lebel”, ACNS2017, p. 59-79
Non-Patent Literature 3: M. Scott, N. Benger, M. Charlemagne“, On the Final Exponentiation for Calculating Pairings on Ordinary Elliptic Curves”, Pairing 2009, p. 78-88

### SUMMARY OF INVENTION

### Technical Problem

Each λᵢ(x) of the hard part necessary to compute the final exponentiation depends largely on a polynomial parameter of an elliptic curve. Accordingly, there is no general method of efficiently computing the hard part. Depending on the elliptic curve, an efficient method of computing the hard part is unknown. Further, even when an efficient computation method of the hard part is known, it is necessary to prepare a means of computing the hard part in advance for each elliptic curve.

An objective of the present disclosure is to make it possible to efficiently compute final exponentiation in pairing computation.

### Solution to Problem

A final exponentiation computation device according to the present disclosure includes:

a decomposition unit to decompose an exponent portion of a final exponentiation computation portion of pairing computation in an elliptic curve into an easy part and a hard part with using a polynomial Φₖ(p(x)), the elliptic curve being expressed by: a polynomial r(x)=Φₖ(T(x))/h₂(x), a polynomial p(x)=h₁(x)r(x)+T(x), and a polynomial t(x)=T(x)+1 which are expressed with using a cyclotomic polynomial Φₖ(x) having a degree d and indicated by Formula 1, a polynomial T(x), a polynomial h₁(x), and a polynomial h₂(x); and an embedding degree k; and an exponentiation computation unit to compute the hard part obtained by decomposition with the decomposition unit, with using a power of a polynomial p(x)ⁱ for each integer i of i=0, . . . , d−1, a power of λ_{d-i}(x) where λ_{d-i}(x)=c_{d}, a power of λᵢ where λᵢ=T(x)λᵢ₊₁(x)+cᵢ₋₁ for each integer i of i=1, . . . , d−2, a power of h₁(x), a power of h₂(x), and at least one of multiplication and inverse element computation.

$${Φ}_{k} ( x ) = {\sum }_{i = 0}^{d} {c}_{i} {x}^{i} \qquad [ Formula 1 ]$$

### Advantageous Effects of Invention

The present disclosure enables efficient final exponentiation computation that applies to many elliptic curves.

### BRIEF DESCRIPTION OF DRAWINGS

FIG. 1 is a configuration diagram of a final exponentiation computation device 10 according to Embodiment 1.

FIG. 2 is an explanatory diagram of a process of decomposing an exponent (p(x)^{k}−1)/r(x) according to Embodiment 1 into an easy part and a hard part.

FIG. 3 is a flowchart illustrating overall operations of the final exponentiation computation device 10 according to Embodiment 1.

FIG. 4 is a flowchart of an exponentiation simplification process according to Embodiment 1.

FIG. 5 is a flowchart of an exponentiation computation process according to Embodiment 1.

FIG. 6 is a configuration diagram of a final exponentiation computation device 10 according to Modification 1.

FIG. 7 is a configuration diagram of a pairing computation device 30 according to Modification 3.

FIG. 8 is a configuration diagram of a cryptographic processing device 40 according to Embodiment 2.

FIG. 9 is a flowchart illustrating operations of the cryptographic processing device 40 according to Embodiment 2.

### DESCRIPTION OF EMBODIMENTS

### Embodiment 1

*** Description of Notation ***

In the specification and drawings, sometimes exponentiation is expressed using “\hat{ }”. In a specific example, a\hat{ }b expresses a^{b}.

*** Description of Configuration ***

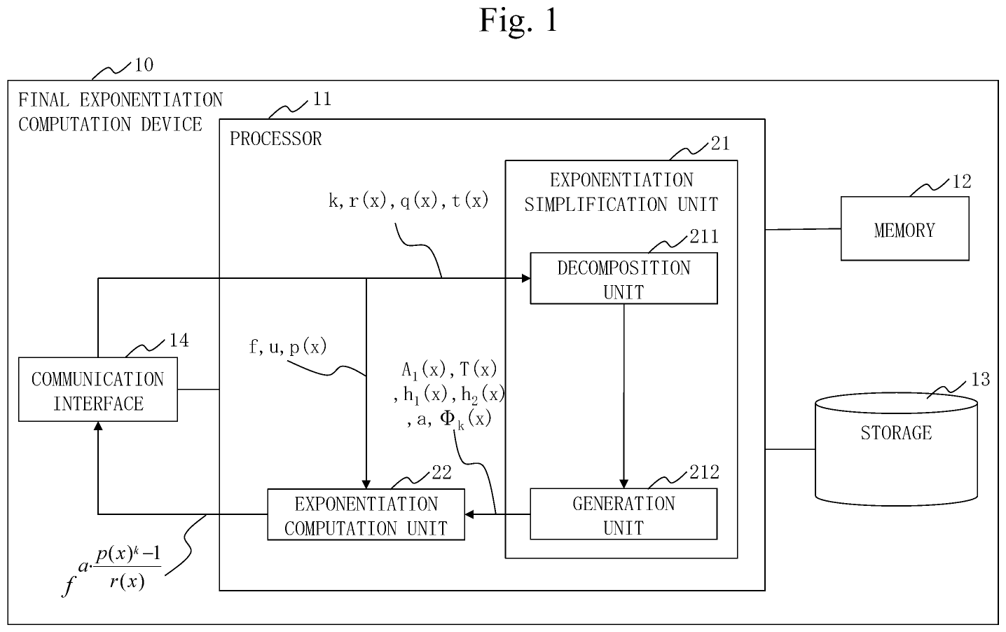

A configuration of a final exponentiation computation device 10 according to Embodiment 1 will be described with referring to FIG. 1.

The final exponentiation computation device 10 is a computer.

The final exponentiation computation device 10 is provided with hardware devices which are a processor 11, a memory 12, a storage 13, and a communication interface 14. The processor 11 is connected to the other hardware devices via a signal line and controls the other hardware devices.

The processor 11 is an Integrated Circuit (IC) to perform processing. Specific examples of the processor 11 are a Central Processing Unit (CPU), a Digital Signal Processor (DSP), and a Graphics Processing Unit (GPU).

The memory 12 is a storage device to store data temporarily. Specific examples of the memory 12 are a Static Random-Access Memory (SRAM) and a Dynamic Random-Access Memory (DRAM).

The storage 13 is a storage device to keep data. A specific example of the storage 13 is a Hard Disk Drive (HDD). The storage 13 may be a portable recording medium such as a Secure Digital (SD, registered trademark) memory card, a CompactFlash (registered trademark, CF), a NAND flash, a flexible disk, an optical disk, a compact disk, a Blu-ray (registered trademark) Disc, and a Digital Versatile Disk (DVD).

The e communication interface 14 is an interface to communicate with an external device. Specific examples of the communication interface 14 are an Ethernet (registered trademark) port, a Universal Serial Bus (USB) port, and a High-Definition Multimedia Interface (HDMI) Port.

The final exponentiation computation device 10 is provided with an exponentiation simplification unit 21 and an exponentiation computation unit 22 as feature constituent elements. The exponentiation simplification unit 21 is provided with a decomposition unit 211 and a generation unit 212. Features of the feature constituent elements of the final exponentiation computation device 10 are implemented by software.

A program that implements the features of the feature constituent elements of the final exponentiation computation device 10 is stored in the storage 13. This program is read into the memory 12 by the processor 11 and run by the processor 11. The features of the feature constituent elements of the final exponentiation computation device 10 are thus implemented.

FIG. 1 illustrates a configuration having one processor 11. However, there may be a plurality of processors 11. The plurality of processors 11 may cooperate with each other to run the program that implements the individual features.

*** Description of Operations ***

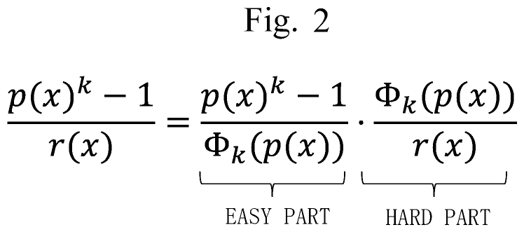

Operations of the final exponentiation computation device 10 according to Embodiment 1 will be described with referring to FIGS. 2 to 5.

An operation procedure of the final exponentiation computation device 10 according to Embodiment 1 corresponds to a final exponentiation computation method according to Embodiment 1. A program that implements the operations of the final exponentiation computation device 10 according to Embodiment 1 corresponds to a final exponentiation computation program according to Embodiment 1.

Embodiment 1 uses a curve to be parameterized by a family of elliptic curves defined in a literature “[FST10] D. Freeman, M. Scott and E. Teske, “A Taxonomy of Pairing-Friendly Elliptic Curves”, J. Cryptol. (2010) 23:224-280.”

The curve to be parameterized by the family of elliptic curves defined in the above literature is an elliptic curve determined by a polynomial r(x), a polynomial p(x), a polynomial t(x), an embedding degree k, and an integer u to be assigned to a variable x. This elliptic curve E is an elliptic curve defined over a finite field Fₚ consisting of elements which are p=p(x) primes. Note that r=r(x) is a maximum prime that divides an order of a subgroup E(Fₚ) of the elliptic curve E. Also, t=t(x) is a trace of the elliptic curve E. In Embodiment 1, the polynomial t(x) being the trace of the elliptic curve is first-order linear. In a specific example, in Embodiment 1, the polynomial t(x)=x+1 which is the trace of the elliptic curve E.

Pairing computation on the elliptic curve E is performed by taking as input two certain points P and Q on the elliptic curve E, computing f obtained by evaluation of a rational function called the Miller function with P, and after that raising f to a power of (p(x)k−1)/r(x). First-half f computation is called Miller loop computation. Second-half exponentiation computation is called computation of final exponentiation.

In the computation of final exponentiation, as illustrated in FIG. 2, an exponent (p(x)^{k}−1)/r(x) is decomposed into an easy part and a hard part with using a polynomial Φₖ(p(x)). Exponentiation computation of the easy part can be efficiently performed using a fast power of p(x)ⁱ. On the other hand, in exponentiation computation of the hard part, the power of x (power of u) must be executed a plurality of times, and thus a computation amount is large. Therefore, an efficient computation method of the hard part is necessary to achieve efficient final exponentiation.

As indicated by Formula 13, the polynomial p(x), the polynomial r(x), and the polynomial t(x) which are parameters of the curve to be parameterized by the family of elliptic curves can be expressed with using a certain polynomial T(x), a certain polynomial h₁(x), and a certain polynomial h₂(x).

$$for T ( x ) , {h}_{1} ( x ) , {h}_{2} ( x ) ∈ Q [ x ] \\ r ( x ) = \frac{{Φ}_{k} ( T ( x ) )}{{h}_{2} ( x )} , \\ p ( x ) = {h}_{1} ( x ) r ( x ) + T ( x ) , \\ t ( x ) = T ( x ) + 1 \qquad [ Formula 13 ]$$

At this time, as indicated by Formula 14, the hard part can be computed with using a power of T(x), a power of h₁(x), a power of h₂(x), and at least one of multiplication and inverse element computation.

$$for d = deg ( {Φ}_{k} ( x ) ) , {Φ}_{k} ( x ) = {\sum }_{i = 0}^{d} {c}_{i} {x}^{i} \\ \frac{{Φ}_{k} ( p ( x ) )}{r ( x )} = {h}_{1} ( x ) ( {\sum }_{i = 0}^{d - 1} {λ}_{i} ( x ) {p ( x )}^{i} ) + {h}_{2} ( x ) where \\ {λ}_{d - 1} ( x ) = {c}_{d} , \\ {λ}_{i} ( x ) = T ( x ) {λ}_{i + 1} ( x ) + {c}_{i + 1} \qquad [ Formula 14 ]$$

Since an embedding degree k of a practical elliptic curve is small, each coefficient cᵢ of a cyclotomic polynomial Φₖ(x) is −1, 0, or 1.

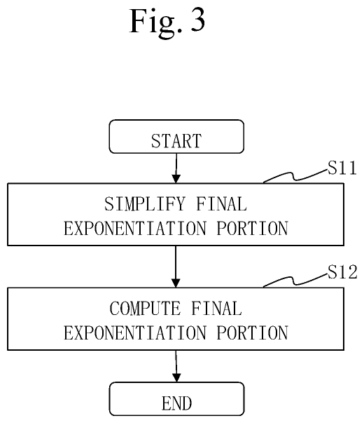

Overall operations of the final exponentiation computation device 10 according to Embodiment 1 will be described with referring to FIG. 3.

(Step S11: Exponentiation Simplification Process)

The decomposition unit 211 of the exponentiation simplification unit 21 decomposes (p(x)^{k}−1)/r(x), being an exponent portion in the final exponentiation computation portion, into an easy part and a hard part. The easy part is a portion expressed by exponentiation of p(x). The hard part is a portion expressed by p(x) and exponentiation of x (exponentiation of u).

The generation unit 212 of the exponentiation simplification unit 21 computes the polynomial T(x), the polynomial h₁(x), the polynomial h₂(x), and an integer a which are necessary for computing the hard part, from the polynomial p(x), the polynomial r(x), the polynomial t(x), and the embedding degree k.

Note that the integer a is a positive, minimum and non-zero integer that renders every coefficient of ah₁(x) and ah₂(x) an integer. Since a fraction may appear in at least one coefficient of the polynomial h₁(x) and polynomial h₂(x), in processing to be described below, multiplication by the integer a is performed to cancel a denominator of the coefficient from the polynomial h₁(x) and the polynomial h₂(x).

(Step S12: Exponentiation Computation Process)

The exponentiation computation unit 22 performs, for the rational function f computed by the Miller loop, exponentiation computation of the easy part obtained in step S11, and exponential computation of the hard part, with using the polynomial T(x), the polynomial h₁(x), the polynomial h₂(x), and the integer a which are obtained in step S11. Thus, the final exponentiation indicated by Formula 15 is performed.

$${f}^{a \cdot \frac{{p ( x )}^{k} - 1}{r ( x )}} \qquad [ Formula 15 ]$$

A result of raising pairing computation to the power of the integer a is computed because the polynomial h₁(x) and the polynomial h₂(x) are multiplied by the integer a in processing to be described later.

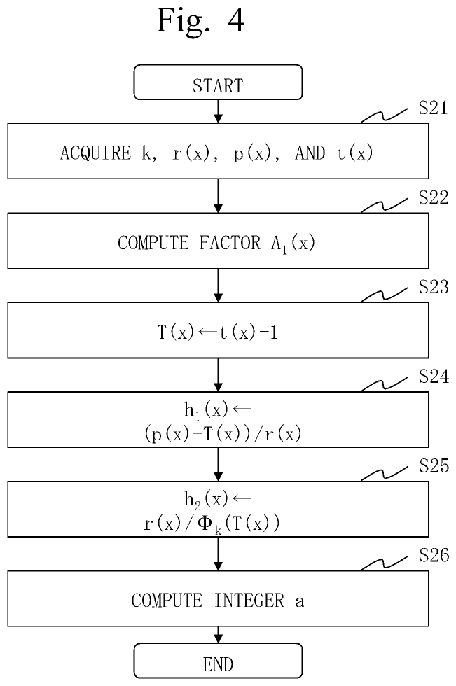

The exponentiation simplification process according to Embodiment 1 will be described with referring to FIG. 4.

In step S21, the exponentiation simplification unit 21 acquires the embedding coefficient k, the polynomial r(x), the polynomial p(x), and the polynomial t(x) about the elliptic curve E.

In step S22, the decomposition unit 211 computes a factor A₁(x) of (p(x)^{k}−1)/r(x). The factor A₁(x) is an entire portion of the easy part illustrated in FIG. 2. The decomposition unit 211 writes the factor A₁(x) to the memory 12.

In step S23 through step S26, the generation unit 212 generates the polynomial T(x), the polynomial h₁(x), the polynomial h₂(x), and the integer a which are necessary for the exponentiation of the hard part, with using a condition of Formula 13.

In step S23, the generation unit 212 generates the polynomial T(x) by T(x)=t(x)−1, and writes it to the memory 12.

In step S24, the generation unit 212 generates the polynomial h₁(x) by h₁(x)=(p(x)−T(x))/r(x), and writes it to the memory 12.

In step S25, the generation unit 212 generates the polynomial h₂(x) by h₂(x)=r(x)/Φₖ(T(x)), and writes it to the memory 12.

In step S26, the generation unit 212 computes the integer a. The integer a is a positive, minimum and non-zero integer that renders every coefficient of ah₁(x) and ah₂(x) an integer. The generation unit 212 writes the generated integer a to the memory 12.

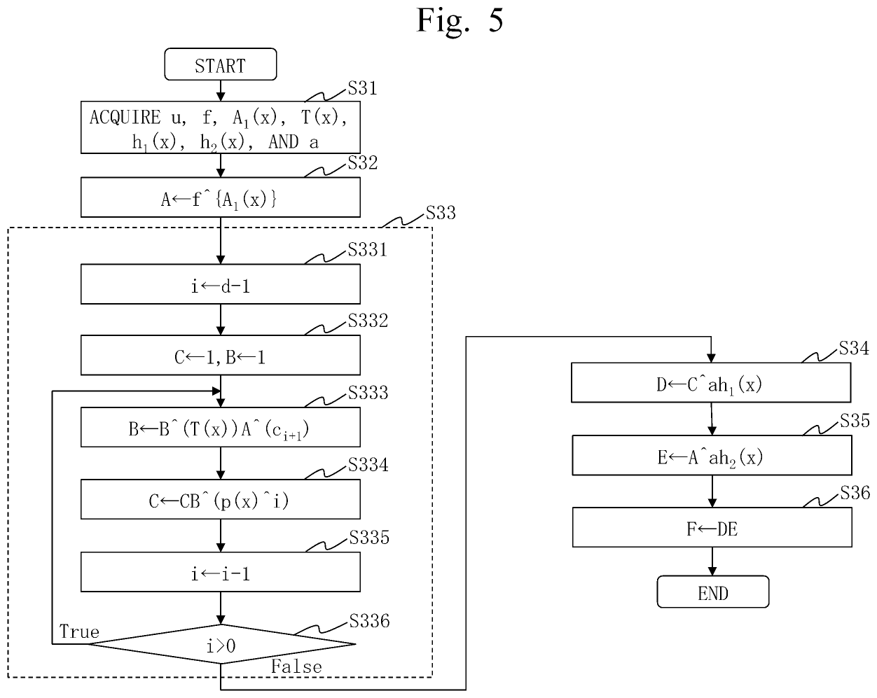

The exponentiation computation process according to Embodiment 1 will be described with referring to FIG. 5.

In step S31, the exponentiation computation unit 22 reads the integer u, the value f computed by the Miller loop, and the factor A₁(x), the polynomial T(x), the polynomial h₁(x), the polynomial h₂(x), and the integer a which are generated by the exponentiation simplification process, from the memory 12. Notation that uses the variable x of a polynomial is employed in the description below. In practice, computation is performed by assigning the integer u to the variable x.

In step S32, the exponentiation computation unit 22 generates a value A=f\hat{ }{A₁(x)} by performing exponentiation where the value f is the base and the factor A₁(x) is the exponent. In short, the exponentiation computation unit 22 computes the value A by Formula 16.

A=fA₁(x) [Formula 16]

In step S33, the exponentiation computation unit 22 generates a value C by performing exponentiation where the value A is the base and a linear sum of p(x)ᵢ of Formula 14 is the exponent. In short, the exponentiation computation unit 22 computes the value C by Formula 17.

$$C = {A}^{{\sum }_{i = 0}^{d - 1} {λ}_{i} ( x ) {p ( x )}^{i}} \qquad [ Formula 17 ]$$

In step S34, the exponentiation computation unit 22 generates a value D by performing exponentiation where the value C is the base and ah₁(x) is the exponent. In short, the exponentiation computation unit 22 computes the value D by Formula 18.

D=C^{ah}^{₁}(x) [Formula 16]

In step S35, the exponentiation computation unit 22 generates a value E by performing exponentiation where the value A is the base and ah₂(x) is the exponent. In short, the exponentiation computation unit 22 computes the value E by Formula 19.

E=A^{ah}^{₂}(x) [Formula 19]

In step S36, the exponentiation computation unit 22 generates a value F by computing a product of the value D and the value E. The value F is a result of pairing computation indicated by Formula 15. That is, in step S33 through step S36, the exponentiation computation unit 22 performs exponentiation of the hard part by using the power of T(x), the power of h₁(x), the power of h₂(x), and at least one of multiplication and inverse element computation in accordance with Formula 14.

A computation process of the value C in step S33 will be described.

In step S331, the exponentiation computation unit 22 initializes an index i by i=d−1.

In step S332, the exponentiation computation unit 22 initializes the value C to 1 and the value B to 1.

In step S333, the exponentiation computation unit 22 performs exponentiation where the value B is the base and T(x) is the exponent. Also, the exponentiation computation unit 22 performs exponentiation where the value A is the base and cᵢ₊₁ is the exponent. Then, the exponentiation computation unit 22 updates the value B by computing a product of the two computed values. In short, the exponentiation computation unit 22 overwrites the value B with a value obtained by Formula 20.

B=B^{T(x)}A^{c}^{ᵢ₊}1 [Formula 20]

Since the embedding degree k of the practical elliptic curve is small, each coefficient cᵢ of the cyclotomic polynomial Φₖ(x) is −1, 0, or 1. Thus, in practice, exponentiation of the base A in step S333 is not necessary, and multiplication of the value A or multiplication of an inverse element A⁻¹ suffices. The inverse element A⁻¹ may be computed in step S333, or may be computed in advance and used repeatedly.

In step S334, the exponentiation computation unit 22 performs exponentiation where the value B is the base and p(x)ⁱ is the exponent, and further computes a product with the value C, thereby updating the value C. In short, the exponentiation computation unit 22 overwrites the value C with a value obtained by Formula 21.

C=CBP(x)ⁱ [Formula 21]

In step S335, the exponentiation computation unit 22 decrements the index i by 1.

In step S336, the exponentiation computation unit 22 determines if the index i is not less than 0 or not. If the index i is not less than 0, the exponentiation computation unit 22 returns to the process of step S333. If the index i is less than 0, the exponentiation computation unit 22 moves forward to the process of step S34. That is, the exponentiation computation unit 22 updates the value C and the value B by executing the processes of step S333 and step S334 sequentially for the index i=d−1, d−2, . . . , 1, 0.

The value C updated by step S33 is a result of exponentiation indicated by Formula 17.

Examples of specific curves will be described.

### Example 1: BLS-9

An example in which the curve is a BLS-9 curve will be described.

In this case, the polynomial t(x)=x+1, the polynomial r(x)=⅓Φₚ(x)=⅓(x⁶+x³+1), and the polynomial p(x)=(x−1)²r(x)+x. Accordingly, the polynomial T(x)=x, the polynomial h₁(x)=(x−1)², and the polynomial h₂(x)=3. Hence, the exponent portion is decomposed as in Formula 22.

$$\frac{{p ( x )}^{9} - 1}{r ( x )} = ( {p ( x )}^{3} - 1 ) \cdot ( {( x - 1 )}^{2} {\sum }_{i = 0}^{5} {λ}_{i} ( x ) {p ( x )}^{i} + 3 ) \qquad [ Formula 22 ]$$

Note that λ₅(x)=1, λ₄(x)=xλ₅(x), λ₃(x)=xλ₄(x), λ₂(x)=xλ₃(x), +1, λ₁(x)=xλ₂(x), and λ₀(x)=xλ₁(x).

### Example 2: BLS-12

An example in which the curve is a BLS-12 curve will be described.

In this case, the polynomial t(x)=x+1, the polynomial r(x)=Φ₁₂(x)=x⁴−x²+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 23.

$$3 \cdot \frac{{p ( x )}^{12} - 1}{r ( x )} = ( {p ( x )}^{6} - 1 ) ( {p ( x )}^{2} + 1 ) \cdot ( {( x - 1 )}^{2} {\sum }_{i = 0}^{3} {λ}_{i} ( x ) {p ( x )}^{i} + 3 ) \qquad [ Formula 23 ]$$

Note that λ₃(x)=1, λ₂(x)=xλ₃(x), λ₁(x)=xλ₂(x)−1, and λ₀(x)=xλ₁(x).

### Example 3: k=12

An example of a curve with an embedding degree k=12 (not a BLS curve) will be described.

In this case, the polynomial t(x)=x+1, the polynomial r(x)=Φ12(x)=x⁴−x²+1, and the polynomial p(x)=¼(x−1)²(x²+1)r(x)+x. Accordingly, the polynomial T(x)=x, the polynomial h₁(x)=¼(x−1)²(x²+1), and the polynomial h₂(x)=1. Hence, the exponent portion is decomposed as in Formula 24.

$$4 \cdot \frac{{p ( x )}^{12} - 1}{r ( x )} = ( {p ( x )}^{6} - 1 ) ( {p ( x )}^{2} + 1 ) \cdot ( {( x - 1 )}^{2} ( {x}^{2} + 1 ) {\sum }_{i = 0}^{3} {λ}_{i} ( x ) {p ( x )}^{i} + 4 ) \qquad [ Formula 24 ]$$

Note that λ₃(x)=1, λ₂(x)=xλ₃(x), λ₁(x)=xλ₂(x)−1, and λ₀(x)=xλ₁(x).

### Example 4: BLS-15

An example in which the curve is a BLS-15 curve will be described.

In this case, the polynomial t(x)=x+1, the polynomial r(x)=Φ₁₅(x)=x⁸−x⁷+x⁵−x⁴+x³−x+1, and the polynomial p(x)=⅓(x−1)²(x²+x+1)r(x)+x. Accordingly, the polynomial T(x)=x, the polynomial h₁(x)=⅓(x−1)²(x²+x+1), and the polynomial h₂(x)=1. Hence, the exponent portion is decomposed as in Formula 25.

$$3 \cdot \frac{{p ( x )}^{15} - 1}{r ( x )} = ( {p ( x )}^{5} - 1 ) ( {p ( x )}^{2} + p ( x ) + 1 ) \cdot \qquad [ Formula 25 ]$$

$$( {( x - 1 )}^{2} ( {x}^{2} + x + 1 ) {\sum }_{i = 0}^{7} {λ}_{i} ( x ) {p ( x )}^{i} + 3 )$$

Note that λ₇(x)=1, λ₆(x)=xλ₇(x)−1, λ₅(x)=xλ₆(x), λ₄(x)=xλ₅(x)+1, λ₃(x)=xλ₄(x)−1, λ₂(x)=xλ₃(x)+1, λ₁(x)=xλ₂(x), and λ₀(x)=xλ₁(x)−1.

### Example 5: BLS-24

An example in which the curve is a BLS-24 curve will be described.

In this case, the polynomial t(x)=x+1, the polynomial r(x)=Φ₂₄(x)=x⁸−x⁴+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 26.

$$3 \cdot \frac{{p ( x )}^{24} - 1}{r ( x )} = ( {p ( x )}^{12} - 1 ) ( {p ( x )}^{4} + 1 ) \cdot ( {( x - 1 )}^{2} {\sum }_{i = 0}^{7} {λ}_{i} ( x ) {p ( x )}^{i} + 3 ) \qquad [ Formula 26 ]$$

Note that λ₇(x)=1, λ₆(x)=xλ₇(x), λ₅(x)=xλ₆(x), λ₄(x)=xλ₅(x), λ₃(x)=xλ₄(x)−1, λ₂(x)=xλ₃(x), λ₁(x)=xλ₂(x), and λ₀(x)=xλ₁(x).

### Example 6: BLS-27

An example in which the curve is a BLS-27 curve will be described.

In this case, the polynomial t(x)=x+1, the polynomial r(x)=⅓Φ₂₇(x)=⅓(x¹⁸+x⁹+1), and the polynomial p(x)=(x−1)²r(x)+x. Accordingly, the polynomial T(x)=x, the polynomial h₁(x)=(x−1)², and the polynomial h₂(x)=3. Hence, the exponent portion is decomposed as in Formula 27.

$$\frac{{p ( x )}^{27} - 1}{r ( x )} = ( {p ( x )}^{9} - 1 ) \cdot ( {( x - 1 )}^{2} {\sum }_{i = 0}^{17} {λ}_{i} ( x ) {p ( x )}^{i} + 3 ) \qquad [ Formula 27 ]$$

Note that λ₁₇(x)=1, λ₁₆(x)=xλ₁₇(x), λ₁₅(x)=xλ₁₆(x), λ₁₄(x)=xλ₁₅(x), λ₁₃(x)=xλ₁₄(x), λ₁₂(x)=xλ₁₃(x), λ₁₁(x)=xλ₁₂(x), λ₁₀(x)=xλ₁₁(x), λ₉(x)=xλ₁₀(x), λ₈(x)=xλ₉(x)+1, λ₇(x)=λ₈(x), λ₆(x)=xλ₇(x), λ₅(x)=xλ₆(x), λ₄(x)=xλ₅(x), λ₃(x)=xλ₄(x), λ₂(x)=xλ₃(x), λ₁(x)=xλ₂(x), and λ₀(x)=xλ₁(x).

### Example 7: BLS-28

An example in which the curve is a BLS-28 curve will be described.

In this case, the polynomial t(x)=x+1, the polynomial r(x)=Φ₂₈(X)=x¹²−λ¹⁰+x⁸−x⁶+x⁴−x²+1), and the polynomial p(x)=⅓(x−1)²(x²+1)r(x)+x. Accordingly, the polynomial T(x)=x, the polynomial h₁(x)=⅓(x−1)²(x²+1), and the polynomial h₂(x)=1. Hence, the exponent portion is decomposed as in Formula 28.

$$3 \cdot \frac{{p ( x )}^{28} - 1}{r ( x )} = ( {p ( x )}^{14} - 1 ) ( {p ( x )}^{2} + 1 ) \cdot ( {( x - 1 )}^{2} ( {x}^{2} + 1 ) {\sum }_{i = 0}^{11} {λ}_{i} ( x ) {p ( x )}^{i} + 3 ) \qquad [ Formula 28 ]$$

Note that λ₁₁(x)=1, λ₁₀(x)=xλ₁₁(x), λ₉(x)=xλ₁₀(x)−1, λ₈(x)=xλ₉(x), λ₇(x)=λ₈(x)+1, λ₆(x)=xλ₇(x), λ₅(x)=xλ₆(x)−1, λ₄(x)=xλ₅(x), λ₃(x)=xλ₄(x)+1, λ₂(x)=xλ₃(x), λ₁(x)=xλ₂(x)−1, and λ₀(x)=xλ₁(x).

### Example 8: k=28

An example of a curve with an embedding degree k=28 (not a BLS curve) will be described.

In this case, the polynomial t(x)=x+1, the polynomial r(x)=Φ₂₈(x)=x¹²−x¹⁰+x⁸−x⁶+x⁴−x²+1, and the polynomial p(x)=¼(x−1)²(x²+1)r(x)+x. Accordingly, the polynomial T(x)=x, the polynomial h₁(x)=¼(x−1)²(x²+1), and the polynomial h₂(x)=1. Hence, the exponent portion is decomposed as in Formula 29.

$$4 \cdot \frac{{p ( x )}^{28} - 1}{r ( x )} = ( {p ( x )}^{14} - 1 ) ( {p ( x )}^{2} + 1 ) \cdot ( {( x - 1 )}^{2} ( {x}^{2} + 1 ) {\sum }_{i = 0}^{11} {λ}_{i} ( x ) {p ( x )}^{i} + 4 ) \qquad [ Formula 29 ]$$

Note that λ₁₁(x)=1, λ₁₀(x)=xλ₁₁(x), λ9(x)=xλ₁₀(x)−1, λ₈(x)=xλ₉(x), λ₇(x)=λ₈(x)+1, λ₆(x)=xλ₇(x), λ₅(x)=xλ₆(x)−1, λ₄(x)=xλ₅(x), λ₃(x)=λ₄(x)+1, λ₂(x)=xλ₃(x), λ₁(x)=xλ₂(x)−1, and λ₀(x)=xλ₁(x).

### Example 9:BLS-42

An example in which the curve is a BLS-42 curve will be described.

In this case, the polynomial t(x)=x+1, the polynomial r(x)=Φ₄₂(X)=x¹² x¹¹−x⁹−x⁸+x⁶−x⁴−x³+x+1, and the polynomial p(x)=⅓(x−1)²(x²−x+1)r(x)+x. Accordingly, the polynomial T(x)=x, the polynomial h₁(x)=⅓(x−1)²(x²−x+1), and the polynomial h₂(x)=1. Hence, the exponent portion is decomposed as in Formula 30.

$$3 \cdot \frac{{p ( x )}^{42} - 1}{r ( x )} = ( {p ( x )}^{14} - 1 ) ( {p ( x )}^{14} + {p ( x )}^{7} + 1 ) ( {p ( x )}^{2} - p ( x ) + 1 ) \cdot \qquad [ Formula 30 ]$$

$$( {( x - 1 )}^{2} ( {x}^{2} - x + 1 ) {\sum }_{i = 0}^{11} {λ}_{i} ( x ) {p ( x )}^{i} + 3 )$$

Note that λ₁₁(x)=1, λ₁₀(x)=xλ₁₁(x)+1, λ₉(x)=xλ₁₀(x), λ₈(x)=xλ₉(x)−1, λ₇(x)=λ₈(x)−1, λ₆(x)=xλ₇(x), λ₅(x)=xλ₆(x)+1, λ₄(x)=xλ₅(x), λ₃(x)=xλ₄(x)−1, λ₂(x)=xλ₃(x)−1, λ₁(x)=xλ₂(x), and λ₀(x)=xλ₁(x)+1.

### Example 10:BLS-48

An example in which the curve is a BLS-48 curve will be described.

In this case, the polynomial t(x)=x+1, the polynomial r(x)=Φ₄₈(x)=x¹⁶−x⁸+1, and the polynomial p(x)=⅓(x−1)²r(x)+x. Accordingly, the polynomial T(x)=x, the polynomial h₁(x)=⅓(x−1)², and the polynomial h₂(x)=1. Hence, the exponent portion is decomposed as in Formula 31.

$$3 \cdot \frac{{p ( x )}^{48} - 1}{r ( x )} = ( {p ( x )}^{16} - 1 ) ( {p ( x )}^{16} + {p ( x )}^{8} + 1 ) \cdot ( {( x - 1 )}^{2} {\sum }_{i = 0}^{15} {λ}_{i} ( x ) {p ( x )}^{i} + 3 ) \qquad [ Formula 31 ]$$

Note that λ₁₅(x)=1, λ₁₄(x)=xλ₁₅(x), λ₁₃(x)=xλ₁₄(x), λ₁₂(x)=xλ₁₃(x), λ₁₁(x)=xλ₁₂(x), λ₁₀(x)=xλ₁₁(x), λ₉(x)=xλ₁₀(x), λ₈(x)=xλ₉(x), λ₇(x)=λ₈(x)−1, λ₆(x)=xλ₇(x), λ₅(x)=xλ₆(x), λ₄(x)=xλ₅(x), λ₃(x)=xλ₄(x), λ₂(x)=xλ₃(x), λ₁(x)=xλ₂(x), and λ₀(x)=xλ₁(x).

### Effect of Embodiment 1

As described above, the final exponentiation computation device 10 according to Embodiment 1 decomposes the exponent portion into an easy part and a hard part with using the polynomial Φₖ(p(x)), and computes the hard part with using the power of T(x), the power of h₁(x), the power of h₂(x), and at least one of multiplication and inverse element computation. This enables efficient computation of pairing computation.

In particular, the final exponentiation computation device 10 according to Embodiment 1 transforms the hard part into a linear sum of the polynomial p(x)ⁱ on the basis of Formula 14. This enables efficient computation of pairing computation concerning many elliptic curves.

Specifically, as the hard part is transformed into a linear sum of the polynomial p(x)ⁱ on the basis of Formula 14, a number of exponentiation computations of p(x) increases a little, but a number of exponentiation computations of x decreases greatly. It is known that a computation amount of exponentiation computation of x is very large compared to a computation amount of exponentiation computation of p(x). Therefore, the final exponentiation computation device 10 according to Embodiment 1 can perform pairing computation efficiently by transforming the hard part into a linear sum of the polynomial p(x)ⁱ on the basis of Formula 14.

More specifically, particularly, a computation efficiency of the final exponentiation computation can be improved for a family of typical elliptic curves such as BLS-9, BLS-12, BLS-15, BLS-24, BLS-27, and BLS-48 curves having a trace t(x)=x+1 which that have been studied conventionally.

*** Other Configurations ***

<Modification 1>

In Embodiment 1, the feature constituent elements are implemented by software. However, Modification 1 may be possible in which the feature constituent elements are implemented by hardware. A difference of Modification 1 from Embodiment 1 will be described.

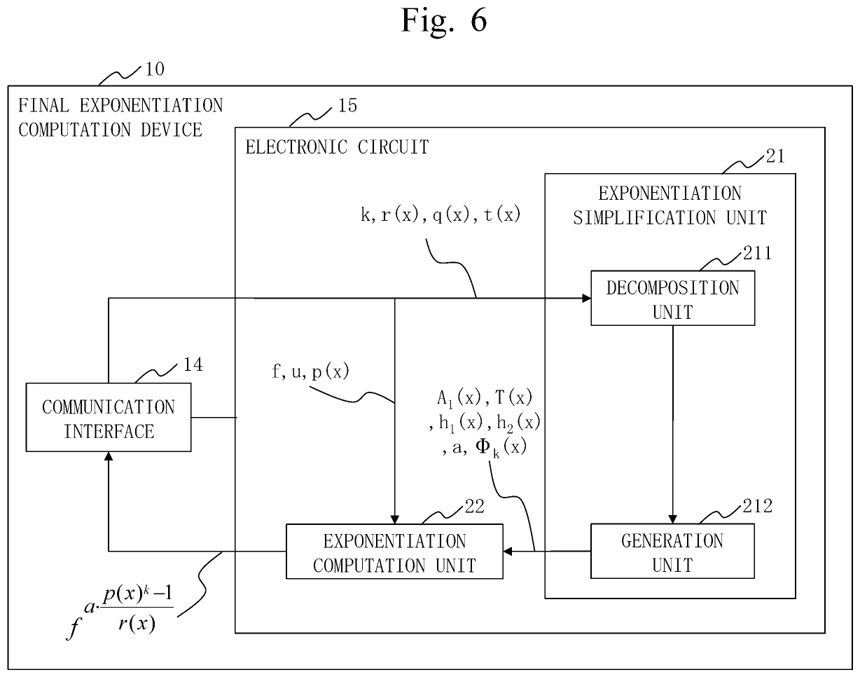

A configuration of a final exponentiation computation device 10 according to Modification 1 will be described with referring to FIG. 6.

When the feature constituent elements are implemented by hardware, the final exponentiation computation device 10 is provided with an electronic circuit 15 in place of a processor 11, a memory 12, and a storage 13. The electronic circuit 15 is a dedicated circuit that implements the features of the feature constituent elements, a feature of the memory 12, and a feature of the storage 13.

The electronic circuit 15 is assumed to be a single circuit, a composite circuit, a programmed processor, a parallel-programmed processor, a logic IC, a Gate Array (GA), an Application Specific Integrated Circuit (ASIC), or a Field-Programmable Gate Array (FPGA).

The feature constituent elements may be implemented by one electronic circuit 15. The feature constituent elements may be decentralized into a plurality of electronic circuits and implemented by the plurality of electronic circuits 15.

<Modification 2>

Modification 2 may be possible in which some of the feature constituent elements are implemented by hardware and the remaining feature constituent elements are implemented by software.

The processor 11, the memory 12, the storage 13, and the electronic circuit 15 are referred to as processing circuitry. That is, the features of the feature constituent elements are implemented by processing circuitry.

<Modification 3>

In Embodiment 1, the final exponentiation computation device 10 which computes only the final exponentiation by acquiring the value f computed by the Miller loop is described. A pairing computation device 30 which performs pairing computation may be formed by adding a feature of performing computation of the Miller loop to the final exponentiation computation device 10 described in Embodiment 1.

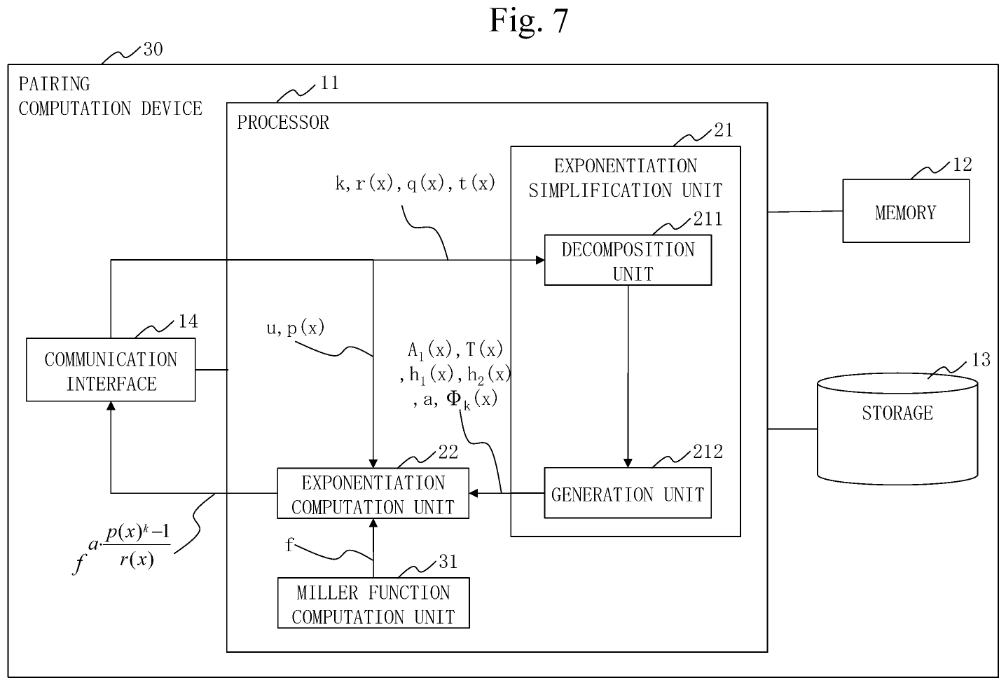

A configuration of a pairing computation device 30 according to Modification 3 will be described with referring to FIG. 7.

The pairing computation device 30 is provided with a Miller function computation unit 31 in addition to the feature constituent elements provided to the final exponentiation computation device 10. The Miller function computation unit 31 is implemented by software or hardware just as the feature constituent elements provided to the final exponentiation computation device 10 are. The Miller function computation unit 31 performs Miller loop computation.

In this case, in step S31 of FIG. 5, an exponentiation computation unit 22 acquires a value f computed by the Miller function computation unit 31.

<Modification 4>

In Embodiment 1, the integer a is computed to cancel the denominator of the coefficient from the polynomial h₁(x) and the polynomial h₂(x). In Embodiment 1, if any coefficient of the polynomial h₁(x) and the polynomial h₂(x) does not include a fraction, 1 will be computed as the integer a. However, if any coefficient of the polynomial h₁(x) and the polynomial h₂(x) does not include a fraction, the integer a need not be computed. In this case, multiplication by the integer a need not be performed in an exponentiation simplification process and an exponentiation computation process.

### Embodiment 2

In Embodiment 1, a computation method of the final exponentiation of the paring computation has been described. In Embodiment 2, a process that uses a result of pairing computation performed in Embodiment 1 will be described. In Embodiment 2, a difference from Embodiment 1 will be described, and a description of the same point as in Embodiment 1 will be omitted.

*** Description of Configuration ***

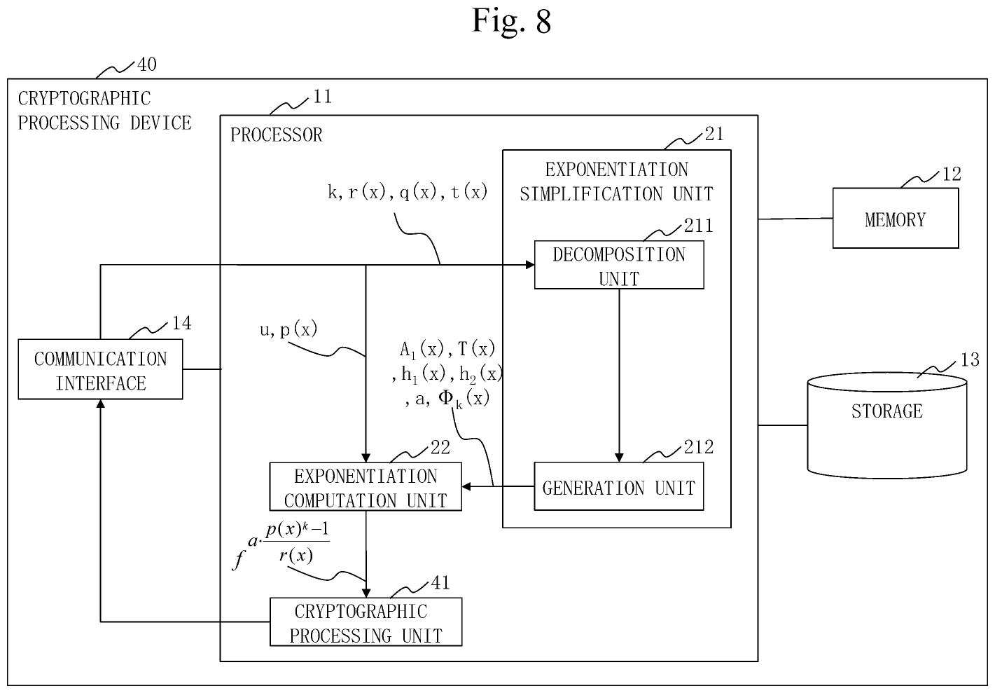

A configuration of a cryptographic processing device 40 according to Embodiment 2 will be described with referring to FIG. 8.

The cryptographic processing device 40 is provided with a cryptographic processing unit 41 in addition to the feature constituent elements provided to the final exponentiation computation device 10 according to Embodiment 1. The cryptographic processing unit 41 is implemented by software or hardware just as the feature constituent elements provided to the final exponentiation computation device 10 are.

*** Description of Operations ***

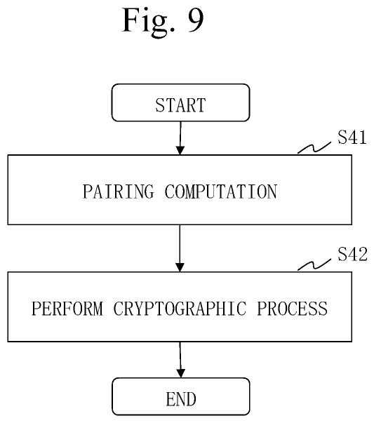

Operations of the cryptographic processing device 40 according to Embodiment 2 will be described with reference to FIG. 9.

An operation procedure of the cryptographic processing device 40 according to Embodiment 2 corresponds to a cryptographic processing method according to Embodiment 2. A program that implements the operations of the cryptographic processing device 40 according to Embodiment 2 corresponds to a cryptographic processing program according to Embodiment 2.

(Step S41: Pairing Computation Process)

A result of pairing computation is computed by the feature constituent elements provided to the final exponentiation computation device 10 according to Embodiment 1. The result of pairing computation is written to a memory 12.

(Step S42: Cryptographic Process)

The cryptographic processing unit 41 performs a cryptographic process with using the result of pairing computation obtained in step S41. The cryptographic process is a process of cryptographic primitive such as an encryption process, a decryption process, a signature process, and a verification process.

The encryption process is a process of converting plaintext-state data into a ciphertext so that the data is kept secret from the third party. The decryption process is a process of converting the ciphertext converted by the encryption process, into the plaintext-state data. The signature process is a process of generating a signature for at least either one of data manipulation detection and data origin confirmation. The verification process is a process of performing at least either one of data manipulation detection and data origin confirmation by the signature generated by the signature process.

For example, the cryptographic processing unit 41 may generate a message decrypted from a ciphertext with using a result of pairing computation that takes as input elements of the ciphertext and elements of a decryption key.

### Effect of Embodiment 2

As described above, the cryptographic processing device 40 according to Embodiment 2 implements the cryptographic process with using the feature constituent elements of the final exponentiation computation device 10 according to Embodiment 1.

The final exponentiation computation device 10 according to Embodiment 1 can perform pairing computation efficiently. Therefore, the cryptographic processing device 40 according to Embodiment 2 can perform the cryptographic process efficiently.

*** Other Configurations ***<

<Modification 5>

In Embodiment 2, the cryptographic processing device 40 is provided with the cryptographic processing unit 41 in addition to the feature constituent elements provided to the final exponentiation computation device 10 according to Embodiment 1. However, the cryptographic processing device 40 may be provided with the cryptographic processing unit 41 in addition to the feature constituent elements provided to the pairing computation device 30 described in Modification 3.

So far, the embodiments and modifications of the present disclosure have been described. Several ones of these embodiments and modifications may be practiced by combination. Also, one or several ones of these embodiments and modifications may be practiced partially. The present disclosure is not limited to the above embodiments and modifications, and various changes can be made to the present disclosure as necessary.

### REFERENCE SIGNS LIST

10: final exponentiation computation device; 11: processor; 12: memory; 13: storage; 14: communication interface; 15: electronic circuit; 21: exponentiation simplification unit; 211: decomposition unit; 212: generation unit; 22: exponentiation computation unit; 30: pairing computation device; 31: Miller function computation unit; 40: cryptographic processing device; 41: cryptographic processing unit.

1. A final exponentiation computation device comprising
processing circuitry
to decompose an exponent portion of a final exponentiation computation portion of pairing computation in an elliptic curve into an easy part and a hard part with using a polynomial Φₖ(p(x)), the elliptic curve being expressed by: a polynomial r(x)=Φₖ(T(x))/h₂(x), a polynomial p(x)=h₁(x)r(x)+T(x), and a polynomial t(x)=T(x)+1 which are expressed with using a cyclotomic polynomial Φₖ(x) having a degree d and indicated by Formula 1, a polynomial T(x), a polynomial h₁(x), and a polynomial h₂(x); and an embedding degree k, and
to compute the hard part obtained by decomposition, with using a power of a polynomial p(x)ⁱ for each integer i of i=0, . . . , d−1, a power of λ_{d-i}(x) where λ_{d-i}(x)=c_{d}, a power of λᵢ where λᵢ=T(x)λᵢ₊₁(x)+cᵢ₊₁ for each integer i of i=1, . . . , d−2, a power of h₁(x), a power of h₂(x), and at least one of multiplication and inverse element computation.
$${Φ}_{k} ( x ) = {\sum }_{i = 0}^{d} {c}_{i} {x}^{i} \qquad [ Formula 1 ]$$

2. The final exponentiation computation device according to claim 1,
wherein the processing circuitry uses a computed result of a power of λᵢ₊₁ when computing the power of λᵢ for each integer i of i=1, . . . , d−2.

3. The final exponentiation computation device according to claim 1,
wherein the processing circuitry computes the hard part by computing Formula 2.
$${h}_{1} ( x ) ( {\sum }_{i = 0}^{d - 1} {λ}_{1} ( x ) {p ( x )}^{i} ) + {h}_{2} ( x ) \qquad [ Formula 2 ]$$

4. The final exponentiation computation device according to claim 1,
wherein the polynomial t(x) is first-order linear.

5. The final exponentiation computation device according to claim 4,
wherein the polynomial t(x)=x+1.

6. The final exponentiation computation device according to claim 1,
wherein the polynomial t(x)=x+1, the polynomial r(x)=⅓Φ₉(x)=⅓(x⁶+x³+1), and the polynomial p(x)=(x−1)²r(x)+x.

7. The final exponentiation computation device according to claim 1,
wherein the polynomial t(x)=x+1, the polynomial r(x)=Φ₁₂(x)=x⁴−x²+1, and the polynomial p(x)=⅓(x−1)²r(x)+x.

8. The final exponentiation computation device according to claim 1,
wherein the polynomial t(x)=x+1, the polynomial r(x)=Φ₁₂(x)=x⁴−x²+1, and the polynomial p(x)=¼(x−1)²(x²+1)r(x)+x.

9. The final exponentiation computation device according to claim 1,
wherein the polynomial t(x)=x+1, the polynomial r(x)=Φ₁₅(x)=x⁸−x⁷+x⁵−x⁴+x³−x+1, and the polynomial p(x)=⅓(x−1)²(x²+x+1)r(x)+x.

10. The final exponentiation computation device according to claim 1,
wherein the polynomial t(x)=x+1, the polynomial r(x)=Φ₂₄(x)=x⁸−x⁴+1, and the polynomial p(x)=⅓(x−1)²r(x)+x.

11. The final exponentiation computation device according to claim 1,
wherein the polynomial t(x)=x+1, the polynomial r(x)=⅓Φ₂₇(x)=⅓(x¹⁸+x⁹+1), and the polynomial p(x)=(x−1)²r(x)+x.

12. The final exponentiation computation device according to claim 1,
wherein the polynomial t(x)=x+1, the polynomial r(x)=Φ₂₈(X)=x¹²−x¹⁰+x⁸−x⁶+x⁴−x²+1), and the polynomial p(x)=⅓(x−1)²(x² 1)r(x)+x.

13. The final exponentiation computation device according to claim 1,
wherein the polynomial t(x)=x+1, the polynomial r(x)=Φ₂₈(x)=x¹²−x¹⁰+x⁸−x⁶+x⁴−x²+1, and the polynomial p(x)=¼(x−1)²(x² 1)r(x)+x.

14. The final exponentiation computation device according to claim 1,
wherein the polynomial t(x)=x+1, the polynomial r(x)=Φ₄₂(X)=x¹²+x¹¹−x⁹−x⁸+x⁶−x⁴−x³+x+1, and the polynomial p(x)=⅓(x−1)²(x²−x+1)r(x)+x.

15. The final exponentiation computation device according to claim 1,
wherein the polynomial t(x)=x+1, the polynomial r(x)=Φ₄₈(x)=x¹⁶−x⁸+1, and the polynomial p(x)=⅓(x−1)²r(x)+x.

16. The final exponentiation computation device according to claim 1,
wherein the easy part is a portion expressed by exponentiation of p(x), and the hard part is a portion expressed by exponentiation of x.

17. A pairing computation device comprising
the final exponentiation computation device according to claim 1,
wherein the processing circuitry computes a Miller function of the paring computation.

18. The pairing computation device according to claim 17,
wherein the processing circuitry performs exponentiation computation of the easy part and exponential computation of the hard part for a function value which is a result of computation of the Miller function, thereby computing a result of the pairing computation.

19. A cryptographic processing device which performs a cryptographic process with using a result of the pairing computation computed by the pairing computation device according to claim 17.

20. A final exponentiation computation method comprising
decomposing an exponent portion of a final exponentiation computation portion of pairing computation in an elliptic curve into an easy part and a hard part with using a polynomial Φₖ(p(x)), the elliptic curve being expressed by: a polynomial r(x)=Φₖ(T(x))/h₂(x), a polynomial p(x)=h₁(x)r(x)+T(x), and a polynomial t(x)=T(x)+1 which are expressed with using a cyclotomic polynomial Φₖ(x) having a degree d and indicated by Formula 3, a polynomial T(x), a polynomial h₁(x), and a polynomial h₂(x); and an embedding degree k, and
computing the hard part with using a power of a polynomial p(x)ⁱ for each integer i of i=0, . . . , d−1, a power of λ_{d-i}(x) where λ_{d-i}(x)=c_{d}, a power of λᵢ where λᵢ=T(x)λᵢ₊₁(x)+cᵢ₊₁ for each integer i of i=1, . . . , d−2, a power of h₁(x), a power of h₂(x), and at least one of multiplication and inverse element computation.
$${Φ}_{k} ( x ) = {\sum }_{i = 0}^{d} {c}_{i} {x}^{i} \qquad [ Formula 3 ]$$

21. A non-transitory computer-readable recording medium recorded with a final exponentiation computation program which causes a computer to function as a final exponentiation computation device that performs:
a decomposition process of decomposing an exponent portion of a final exponentiation computation portion of pairing computation in an elliptic curve into an easy part and a hard part with using a polynomial Φₖ(p(x)), the elliptic curve being expressed by: a polynomial r(x)=Φₖ(T(x))/h₂(x), a polynomial p(x)=h₁(x)r(x)+T(x), and a polynomial t(x)=T(x)+1 which are expressed with using a cyclotomic polynomial Φₖ(x) having a degree d and indicated by Formula 4, a polynomial T(x), a polynomial h₁(x), and a polynomial h₂(x); and an embedding degree k; and
an exponentiation computation process of computing the hard part obtained by the decomposition process, with using a power of a polynomial p(x)ⁱ for each integer i of i=0, . . . , d−1, a power of λ_{d-i}(x) where λ_{d-i} (x)=c_{d}, a power of λᵢ where λᵢ=T(x)λᵢ₊₁(x)+cᵢ₊₁ for each integer i of i=1, . . . , d−2, a power of h₁(x), a power of h₂(x), and at least one of multiplication and inverse element computation.
$${Φ}_{k} ( x ) = {\sum }_{i = 0}^{d} {c}_{i} {x}^{i} \qquad [ Formula 4 ]$$
